(19) United States
(12) Patent Application Publication
(10) Pub. No.: US 2014/0207706 A1
(43) Pub. Date: Jul. 24, 2014

(54) Computer Implemented System and Method for Aggregating, Analyzing and Distributing Information Corresponding to Retirement Plans

(71) Applicant: Congruent Solutions PVT. LTD., Chennai (IN)

(72) Inventor: Rajagopal Sitaram, Chennai (IN)

(73) Assignee: Congruent Solutions PVT. LTD., Chennai (IN)

(21) Appl. No.: 14/194,921

(22) Filed: Mar. 3, 2014

Related U.S. Application Data
(63) Continuation-in-part of application No. 13/398,048, filed on Feb. 16, 2012, now abandoned.

(30) Foreign Application Priority Data
Feb. 17, 2011 (IN) 454/CHE/2011

(51) Int. Cl. G06Q 10/10

(52) U.S. Cl. CPC G06Q 10/1057
USPC 705/36 R

(57) ABSTRACT

A computer implemented system and method for aggregating, analyzing, and distributing information corresponding to retirement plans offered to users have been disclosed. The system includes a database adapted to store at least authentication credentials and payroll information corresponding to users. The system includes a configuration sub-system adapted to configure the retirement plans based on pre-defined rules. The retirement plans are offered to users subsequent to determining, based on the payroll information corresponding to users, whether the users are eligible for a retirement plan. The users who have been identified as eligible are automatically enrolled onto the retirement plan via an enrollment module. The system also enables the users to initiate investment transfers between various plans, reallocation of investments within the same plan and rebalancing of investments within the same plan. The system also allows the plan sponsor/administrator to timely rectify exceptions if any using a user interface.

### CROSS REFERENCE TO RELATED APPLICATIONS

This application is a continuation-in-part (CIP) of U.S. patent application Ser. No. 13/398,048, filed Feb. 16, 2012, now under examination, the disclosure of which is incorporated by reference herein.

### FIELD OF THE DISCLOSURE

The present disclosure relates to the field of retirement plans. Particularly, this disclosure relates to the field of data management system for efficient gathering of information, processing of information to create data and rectification and dissemination of data relating to retirement plans.

### BACKGROUND

Certain percentage of the total workforce retires every year and a substantial number of people inch closer to retirement with passage of every year. Professionals tend to enroll into a retirement plan for receiving future benefits, for example saving money for their old age requirements. Most working professionals tend to adopt an aggressive approach towards obtaining retirement benefit plans when they are on the verge of taking a retirement from their professional careers.

When an employer makes an annual contribution for a particular employee under a defined retirement contribution plan, the retirement solutions provider initiates the processing of a retirement plan. Normally the process of obtaining a retirement plan includes a number of procedural steps which are carried out by the retirement solution provider.

Given below are some of the factors that are responsible for making the task of gathering, analysis, aggregation, rectification and dissemination of data cumbersome and time consuming:

1. Lack of process automation: Lack or absence of process automation leads to decreased productivity. For example, the process of enrolling employees for a new retirement plan, employee registration can be carried out in two ways: Eligible employees can be either asked to register themselves to the newly formed retirement plan or the retirement plan provider or sponsors (designated employees of a sponsoring organization) can choose to upload a single file with the necessary details of all eligible participants. Further, manually filling data related to employee in the data management system increases dependence on manual resources and is prone to errors.

2. Lack of integration with other software products and services: Lack of integration and synchronization measures can render a system to be ineffective and inefficient. A data management system is required to work in close synchronization with other products/management systems that are already available at the consumer's end. Absence of synchronization and integration features will prevent the integration of the data management system with the existing systems thereby rendering it ineffective.

3. Lack of customization: Customizing the business rules underlying the implementation of any currently known data management systems is an arduous task for the end users. Most conventionally known data management systems do not allow the users to easily customize the system as per their needs.

4. Inability to handle large volume implementations: As the number of participants increase, the time taken by the conventional data management system for processing data and processes to get executed can increase exponentially. The data management system must incorporate performance enhancement functionalities that can handle large volumes of information without sacrificing on time. Inability to handle larger volumes of data might render a data management system to be inefficient.

5. Lack of role-based access control rights: Prior art data management systems fail to provide role based access rights to the users of the data management system. Lack of role based access rights makes privileged data available to even those users who would not require the privileged data for the purpose of carrying out their work.

6. Lack of dashboard based approach: A major feature unavailable in data management products available in today's market is the ability to get a cumulative review/or an analytics at one consolidated place i.e. on the user dashboard section. A data management system, in order to be efficient and effective in providing the services needs to address this issue. After logging into the software system, the users should be able to see a list of things-to-do that are organized in the order of priority. Additionally, the users should also be allowed to directly navigate to the pages that host the relevant task. The inclusion of such a feature would save time and effort that is currently spent in navigating (sometimes through complex flows) through different pages before finally arriving at the target destination page.

7. Long waiting time: The prolonged waiting time for error generation and rectification in the primitive data management systems, makes them more tedious and time consuming. This is because of long waiting time for processing the subsequent jobs in the queue/batches and further queuing of new jobs which results in a huge backlog. As per the old system, a file containing the user information is uploaded into the database. The validation rules are applied on the data. If there exists any exceptions or errors, a report is generated which is communicated to the plan sponsors/administrators. Once corrected, the file is re-uploaded into the database. Further, to implement a system which is not able to process its backlogs and update the database timely proves to be very expensive given today's scenario where every second counts.

A number of prior arts have been identified that claim to overcome one or more of the disadvantages mentioned above.

For example, United States Patent Application Publication No. 20060080200 discloses a data management system to electronically provide benefit plan information to the participants. While, the disclosure takes into consideration the different modules that are required to run an electronically controlled benefit plan administration, it stays silent on the need and implementation of quicker error/exception rectification. Also, while the disclosure identifies the sources of error generation, it fails to disclose steps/preventive measures to be taken in order to avoid error propagation.

United States Patent Application Publication No. 20030105692 discloses an interface based retirement funds management system. While, the disclosure covers the major requirements needed for implementing an interface based retirement funds management system, it stays silent about the process needed to expedite the error/exception correction. Also, though the disclosure mentions about the use of corrections/adjustment panels to ensure correctness of information, it fails to provide any explanations to automate and expedite the error/exception correction process.

To overcome the disadvantages associated with the prior art systems, the present disclosure proposes a system which:
implements a web based self-service platform;
captures the necessary information at the source without losing control over the process of capturing the information;
abstains from stitching the individual data sets together;
provides highly automated business processes;
provides customizable plan templates and customizable business work flow structures;
offers services which can be deployed at separate, remotely located servers;
ensures data concurrency by isolating the transactions performed on the stored data; and
accelerates exception/error identification and correction.

### OBJECTS

Some of the objects of the present disclosure, which at least one embodiment herein satisfies are as follows:

It is an object of the present disclosure to provide a system that implements a web based self-service platform.

Another object of the present disclosure is to provide a system that captures the necessary information at the source without losing control over the process of capturing the information.

Yet another object of the present disclosure is to provide a system that abstains from stitching the individual data sets together.

Still a further object of the present disclosure is to provide a system that provides highly automated business processes.

Another object of the present disclosure is to provide a system that incorporates a dashboard based approach.

Still a further object of the present disclosure is to provide a system that provides customizable plan templates and business work flow structures.

Still a further object of the present disclosure is to provide a system that offers services which can be deployed at separate, remotely located servers.

Another object of the present disclosure is to provide a system that ensures data concurrency by isolating the transactions performed on the stored data.

Yet another object of the present disclosure is to provide a system that offers services which greatly reduce the time required for exception identification and rectification.

Yet another object of the present disclosure is to provide a system that offers services which are time saving.

Other objects and advantages of the present disclosure will be more apparent from the following description when read in conjunction with the accompanying figures, which are not intended to limit the scope of the present disclosure.

### SUMMARY

In accordance with the present disclosure, there is provided a computer implemented system for managing information related to users and corresponding retirement plans offered to users.

The system, in accordance with the present disclosure includes a database adapted to store the information corresponding to different users and retirement plans available, wherein the information includes at least authentication credentials, payroll information, predefined rules related to different retirement plans and predefined validation rule.

Typically, in accordance with the present disclosure, the system further includes a configuration sub-system adapted to assign a retirement plan to a user based on payroll information for the user and predefined rules associated with the retirement plans.

Additionally, in accordance with the present disclosure, the system further includes a payroll module adapted to generate data by creating a profile corresponding to each user, wherein profile corresponding to each user is created by extracting payroll information corresponding to each user and information regarding retirement plan assigned to each user from the database, the payroll module further adapted to utilize customizable validation rules for validating each profile created corresponding to each user.

Typically, in accordance with the present disclosure, the system further includes a verification sub-system adapted to verify profiles of the data generated by the payroll module based on the validation rules.

Also, in accordance with the present disclosure, the system further includes an exception-management sub-system adapted to identify exceptions in the data generated by the payroll module, wherein the exceptions include profiles having erroneous entries and which deviate from the validation rules.

Additionally, in accordance with the present disclosure, the system further includes a data-segregation sub-system adapted to segregate a portion of the data having exceptions from the data without exceptions, wherein the data without exceptions proceeds for further processing.

Typically, in accordance with the present disclosure, the system further includes a correction sub-system adapted to correct the data having exceptions and direct the data to the exception-management sub-system.

Also, in accordance with the present disclosure, the system further includes a processing engine adapted to transfer the rectified data for end use.

Typically, in accordance with the present disclosure, the system further includes an eligibility module having customizable eligibility rules for identifying and listing users eligible for being enrolled in at least one retirement plan, the eligibility module further adapted to automatically send a notification to listed eligible users inviting them to get enrolled into the retirement plan.

Additionally, in accordance with the present disclosure, the system further includes an enrollment module adapted to automatically enroll the eligible users into at least one retirement plan.

Also, in accordance with the present disclosure, the system further includes a transfer sub-system adapted to enable the users to initiate investment transfer selected from the group of transfer of investments between various plans, reallocation of investments within the same plan, and rebalancing of investments within the same plan.

Typically, in accordance with the present disclosure, the system further includes updating means adapted to periodically update the payroll profiles corresponding to the users, the updating means further adapted to facilitate at least one modification in the beneficiary list(s)—of the retirement plans corresponding to the user's payroll profile.

Typically, in accordance with the present disclosure, the database is further adapted to store at least the pre-defined configuration rules, eligibility rules, and list of eligible users, employee details and user investment details.

Additionally, in accordance with the present disclosure, the eligibility module is further adapted to generate summary reports having at least the payroll details corresponding to eligible users, and detailed reports, the eligibility module further adapted to interlink the summary reports with the detailed reports.

Also, in accordance with the present disclosure, the enrollment module is adapted to automatically transmit a personalized enrollment confirmation to the users enrolled into the retirement plans.

Typically, in accordance with the present disclosure, the user interface is adapted to display the items selected from the group of items consisting of at least payroll profiles, beneficiary lists, user information, user account summary, investment details, transaction history, retirement plan details, contribution details, retirement plan wise investment details and performance of the investment for a particular plan.

Additionally, in accordance with the present disclosure, the system further includes authentication, means communicating with the database and having pre-defined authentication rules and adapted to perform certificate based authentication to verify authentication credentials of the users.

In accordance with the present disclosure, there is provided a method for aggregating, analyzing, distributing information corresponding to retirement plans offered to users, the method comprising the following steps:
a) storing the information corresponding to users, wherein the information includes at least authentication credentials and payroll information corresponding to the users;
b) associating pre-defined rules with the retirement plans and configuring the retirement plans in accordance with the pre-defined rules;
c) verifying profiles of the data generated by the payroll module based on the validation rules;
d) identifying exceptions, the exceptions include the data which fail the validation rules;
e) segregating the data which carry the exceptions from those that do not carry the exceptions;
f) correcting the data which carry the exceptions;
g) re-validating the payroll information with corrected exceptions;
h) repeating steps c to g until the exceptions are corrected;
i) forwarding the data for further processing;
j) identifying and listing, based on customizable eligibility rules, users eligible for being enrolled to at least one retirement plan and automatically sending a notification to the listed eligible users inviting them to get enrolled into the retirement plan;
k) automatically enrolling the eligible users into at least one retirement plan; and
l) enabling the users to initiate investment transfer selected from the group of investment transfers consisting of transfer of investments between various plans, reallocation of investments within the same plan and rebalancing of investments within the same plan.

Typically, in accordance with the present disclosure, the step of storing the information corresponding to users in an encrypted format further includes the step of storing at least pre-defined configuration rules, eligibility rules, list of eligible users, user information and user investment details.

Additionally, in accordance with the present disclosure, the step of receiving the payroll information further includes the step of creating payroll profiles corresponding to each of the users.

Also, in accordance with the present disclosure, the step of identifying and listing, based on customizable eligibility rules, users eligible for being enrolled to at least one retirement plan further includes the step of generating interlinked summary reports and detailed reports corresponding to the users.

Typically, in accordance with the present disclosure, the step of automatically enrolling the eligible users further includes the step of automatically transmitting a personalized enrollment confirmation to the users enrolled onto the retirement plan.

Additionally, in accordance with the present disclosure, the steps of optionally updating the payroll profiles corresponding to the users and optionally modifying the beneficiary lists corresponding to the retirement plans enrolled onto the users.

Also, in accordance with the present disclosure, the method includes the step of performing certificate based authentication credentials of the user.

In accordance with the present disclosure, there is provided a computer program product, comprising a computer usable medium having a computer readable program code embodied therein, the computer readable program code adapted to be executed to implement a method for generating a report, the method comprising:
a) storing the information corresponding to users, wherein the information includes at least authentication credentials and payroll information corresponding to the users;
b) associating pre-defined rules with the retirement plans and configuring the retirement plans in accordance with the pre-defined rules;
c) verifying profiles of the data generated by the payroll module based on the validation rules;
d) identifying exceptions, the exceptions include the data which fail the validation rules;
e) segregating the data which carry the exceptions from those that do not carry the exceptions;
f) correcting the data which carry the exceptions;
g) re-validating the payroll information with corrected exceptions;
h) repeating steps c to g until the exceptions are corrected;
i) forwarding the data for further processing;
j) identifying and listing, based on customizable eligibility rules, users eligible for being enrolled to at least one retirement plan and automatically sending a notification to the listed eligible users inviting them to get enrolled into the retirement plan;
k) automatically enrolling the eligible users into at least one retirement plan; and
l) enabling the users to initiate investment transfer selected from the group of investment transfers consisting of transfer of investments between various plans, reallocation of investments within the same plan and rebalancing of investments within the same plan.

### BRIEF DESCRIPTION OF THE ACCOMPANYING DRAWINGS

The present disclosure will now be described with reference to the non-limiting, accompanying embodiments, in which:

FIG. 1 illustrates a schematic representation depicting interaction of various elements of a system for aggregating information, processing information for creating data, rectifying and distributing data corresponding to retirement plans offered to users in accordance with an embodiment of the present disclosure;

FIG. 2 illustrates a flowchart corresponding to a method of aggregating information, processing information for creating data, rectifying and distributing data corresponding to retirement plans offered to users in accordance with the present disclosure;

FIG. 3 illustrates a schematic representation of the architecture of the system for aggregating information, processing information for creating data, rectifying and distributing data corresponding to retirement plans offered to users; and

FIG. 4 illustrates a flowchart depicting process steps involved in the system for aggregating information, processing information for creating data, rectifying and distributing data, particularly after exception/error identification and correction.

### DETAILED DESCRIPTION

The present disclosure will now be described with reference to the accompanying drawings which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

To overcome the difficulties associated with effective aggregating, analyzing, and distributing information corresponding to retirement plans, the present disclosure proposes a system that treats the steps involved in issuing a retirement plan to the users as a single cycle of steps and provides for an effective collaboration between all the stake holders involved in the process of providing retirement solutions. By treating the steps involved in providing a retirement plan as a single cycle of steps and by ensuring effective collaboration between all the stakeholders involved in the process of providing a retirement solution, the system of the present disclosure provides an efficient, effective and transparent system and method for aggregating, analyzing, rectifying and distributing information corresponding to retirement plans.

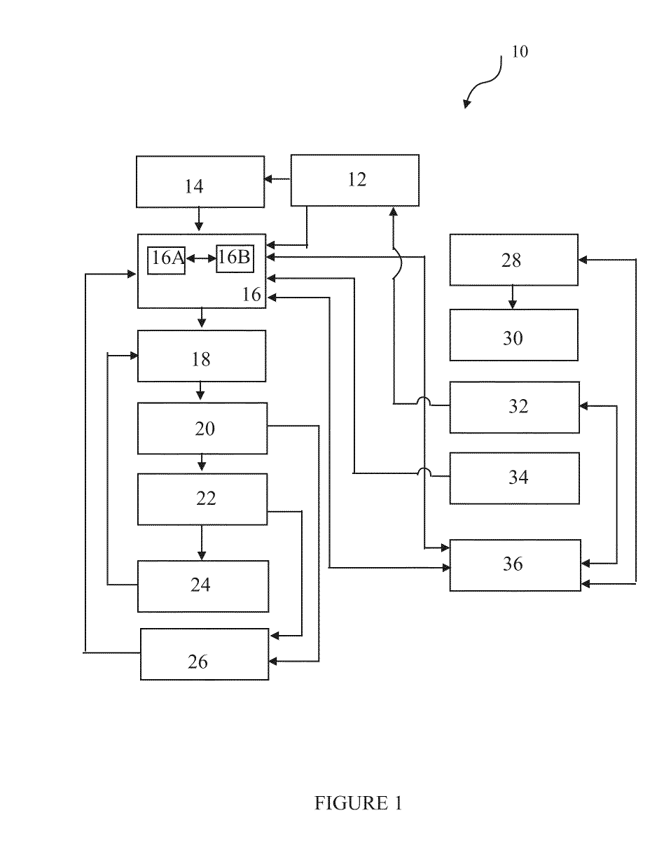

Referring to FIG. 1, there is illustrated a system that facilitates effective and efficient aggregating, analyzing, rectification and distributing information corresponding to retirement plans offered to users. In this specification, the term “user” refers to the users who have enrolled onto at least one retirement plan provided through the system 10. The system 10, in accordance with the present disclosure includes configuration sub-system 14 having pre-defined rules and adapted to configure the retirement plans to be made available to users and associate the pre-defined rules with said retirement plans. The plan administrators/sponsors make the retirement plans configured by the configuration sub-system 14 available to users.

The system 10, in accordance with the present disclosure includes payroll module denoted by the reference numeral 16. The payroll module 16 is utilized by retirement plan administrators or sponsors to upload the payroll details corresponding to every user who wishes to obtain a retirement plan. The data entered by retirement plan administrators or sponsors using the payroll module 16 includes, but is not restricted to hours of service of a user, compensations provided by the employer, loan obtained by the user, monetary contributions from the user and the like. The data entered by retirement plan administrators or sponsors is validated by the payroll module 12 using customizable validation rules. The payroll module 16 includes a profile creator 16A which is adapted to create payroll profiles corresponding to the users by making use of the information provided to the payroll module 16 by retirement plan sponsors/administrators. The payroll module 16 also communicates with a user interface 36 that reports the occurrence of errors in submitted data, to the concerned retirement plan administrator or sponsor. The payroll module 16 further includes an updating means 16B which provides the retirement plan administrator or sponsor with the option of editing and updating the payroll information corresponding to users.

The payroll module 16, using the profile creator means 16A creates individual payroll profiles. The payroll module 16 is further adapted to carry out periodic updates on the created profiles in order to ensure accuracy of data. The predetermined verification rules utilized by the payroll module 16 are flexible and can be customized by the retirement plan administrator or sponsors depending upon their needs. The profiles created by the profile creator 16A can be transferred on to a remote server using well known methodologies including UI (User Interface) based upload and FTP (File Transfer Protocol) based upload.

The payroll module 16 provides the retirement plan administrator or sponsors with the option of uploading the profiles on a one on one basis. The retirement plan administrator or sponsors need not have to wait until all the profiles are generated. As soon as a profile is generated, the payroll module 16 provides the retirement plan administrator or sponsors with the option of uploading the profile onto a remote server. Alternately, the payroll module 16 also provides the retirement plan administrators or sponsors with the option of customizing the format of the payroll profile. The payroll module 16 also takes into consideration certain schedule details including but not restricted to retirement plan start date, retirement plan end date, retirement plan cutoff date and the like while creating the payroll profiles corresponding to users.

The system 10, in accordance with the present disclosure further includes an eligibility module denoted by the reference numeral 28. The eligibility module 28 communicates with the payroll module 16 to receive the generated payroll profiles that correspond to the users willing to avail at least one retirement plan. The eligibility module 28 is adapted to identify and list the users who are eligible for a retirement plan. The identification and listing of eligible users is conducted by the eligibility module 28 based on the analysis of the respective payroll profiles. The users identified and listed by the eligibility module are subsequently invited to obtain the concerned retirement plan.

The eligibility module 28 provides the option of sending either a group invite thereby inviting all the eligible users through a single invitation or sending separate invitations to individual users. The eligibility module 28, in accordance with the present disclosure is further adapted to generate summary reports and detailed reports wherein the summary reports created by the eligibility module 28 include at least the payroll details corresponding to eligible users. The summary reports created by the eligibility module 28 are linked with detailed reports which contain detailed information about the user and the retirement plans the user has enrolled onto.

The system 10, in accordance with the present disclosure further includes an enrollment module denoted by the reference numeral 30. The enrollment module 30 communicates with the eligibility module 28 to receive the list of users who are eligible for at least one retirement plan. The enrollment module 30 provides the identified and listed users with the option of enrolling to the available retirement plans. The users who enroll to a particular retirement plan using the enrollment module 30 are treated as participants in the retirement plan. The enrollment module 30 also provides the users with the facility of performing certain operations including, but not restricted to setting up the access password, entering the personal information, confirming the contribution rate, selecting the amount of investment and the like.

The enrollment module 30 also provides the retirement plan administrators or sponsors with the option of initiating automatic enrollment of eligible users identified and listed by the eligibility module 28. The enrollment module 30 automatically enrolls those eligible users who by themselves have not enrolled to any of the retirement plans (users not having enrolled onto any of the available retirement plans) within the time period available for enrollment. The automatic enrollment carried out by the enrollment module 30 is administered by the retirement plan administrator or sponsors. The enrollment module 30 also sends personalized enrollment confirmations to all the users who get enrolled to the plan either on their own or through the process of automatic enrollment.

The system 10, in accordance with the present disclosure, further includes updating means denoted by the reference numeral 32. The updating means 32 is utilized to update at least the payroll information available within the system 10 which includes at least loans obtained by a user, monetary contributions provided by the employer, compensations received by a user, user's access password, personal information, names of beneficiaries, user's and employer's monthly contribution rate, and amount of investment. The user who has enrolled onto a retirement plan is also provided with the option of editing his/her beneficiary list. The user can add or delete beneficiaries from the corresponding beneficiary list. When the payroll information is altered using the updating means 32, an email notification detailing the alterations is automatically sent by the updating means 32 to the concerned user as well as the concerned plan administrator/sponsor. In case if an organization wishes to enroll its employees for a retirement plan, it can do so by uploading a CSV (Comma Separated Value) file which includes relevant but bulk data that corresponds to the entire Workforce of the organization.

In accordance with the present disclosure, the system 10 includes a verification sub-system 18. The verification sub-system 18 is used to read the data from the database and verify profiles of the data generated by the payroll module 16 based on the validation rules.

In accordance with the present disclosure, the system 10 includes a rule based exception-management sub-system 20. The exception-management module 20 is adapted to identify exceptions in the data generated by the payroll module 16, wherein the exceptions include profiles having erroneous entries and which deviate from the validation rules.

In accordance with the present disclosure, the system 10 includes a data-segregation module 22. The data-segregation sub-system 22 is used to separate the items which carry exceptions/errors from those that do not. The advantage of doing so is to forward the data that do not carry exceptions for further processing. With fluctuating market prices, the timing for buying and selling goods is of key essence. Hence, in one embodiment the data items which are exception free are released, forwarded for further trading.

In accordance with the present disclosure, the system 10 includes a correction sub-system 24. The correction sub-system 24 gives the plan sponsor/administrator the opportunity to correct the values which are identified as exceptions by the validation rules. The corrections are implemented on a real time feedback displayed on the user interface 36.

In accordance with the present disclosure, the system 10 includes a processing engine 26 which further processes the data for trading purposes.

The system 10, in accordance with the present disclosure, includes a transfer sub-system denoted by the reference numeral 34 which provides the registered users of the system 10 with the option of transferring the money invested on a particular investment option in a particular retirement plan to other investment options provided within the same retirement plan. The transfer of investment is permitted only if the transfer of investments is in compliance with the rules corresponding to the current retirement plan. The user is also provided with an option of either transferring the existing monetary investment to other investment options available within the same retirement plan or reallocating the monetary investment within the existing retirement plan or rebalancing the current investment within the existing retirement plan.

The system 10, in accordance with the present disclosure further includes a user interface 36. The user interface 36 communicates with the updating means 32 to receive and display the updated user payroll information. The user interface 36 is also adapted to display the user payroll profile that is generated by the profile creator 16A. The user interface 36 communicates with the payroll module 16 to receive and display the payroll profiles corresponding to the users. The user interface 36 is also adapted to display the list of eligible users identified by the eligibility module 14. The user interface 36 communicates with the eligibility module 28 to receive and display the list of eligible users who were identified by the eligibility module 28. The user-interface 36 is further adapted to display the summary of the account owned by the user.

The account summary displayed by the user interface 36 includes data corresponding to at least investment wise transaction details, source wise transaction details, pending transaction details, account balance details, completed transaction details and performance details corresponding to the investment. The user interface 36 also displays user related information including, but not restricted to user name, designation, user payroll information, user contribution details and investment allocation details. The user interface 36 is further adapted to display the plan summary corresponding to the retirement plan selected by a particular user, which includes the amount invested on the retirement plan.

The system 10, in accordance with the present disclosure includes a database 12 which is adapted to store at least the payroll information and authentication credentials corresponding to the users. The authentication credentials and the payroll information are typically stored in an encrypted format in order to ensure security of the information. The payroll module 16 communicates with the database in order to receive the payroll information corresponding to the users. Typically the customizable validation rules and the eligibility rules are also stored in the database. The eligibility module 28 communicates with the database in order to receive the eligibility rules and accordingly determine whether the users are eligible to avail any of the configured retirement plans.

The database 12, in accordance with the present disclosure also stores the information including but not restricted to beneficiary lists corresponding to retirement plans, user information, user account summary, investment details, transaction history, retirement plan details, contribution details, retirement plan wise investment details and performance of the investment for a particular plan.

In accordance with the present disclosure, the user interface 36 of the system displays a dashboard to retirement plan sponsors and administrators. The dashboard is typically displayed on the ‘Home Page’ of respective Plan Sponsors and Administrators. The dashboard contains a plurality of placeholders which in turn hold different types of information (including at least static information and dynamic information). These information sets include but are not restricted to to-do lists, alerts and general information corresponding to retirement plans. The dashboard can also contain dynamic links and information customized according to the needs of plan sponsors/administrators. All the transactions performed on the dashboard are recorded and stored in the form of tables in the database 12. The system 10 makes use of a generic software program which is invoked from all the methods under execution in order to track, record the transactions performed on the dashboard displayed to plan sponsors/administrators.

In accordance with the present disclosure, the system 10 further includes a notes manager (not shown in figures) which enables the user to make notes for every transaction he performs on the system 10. On every webpage displayed on the user interface 36 there is provided a link which invokes a text area with previous notes, if any. The text area is invoked from a master page that acts as a central place where changes to the notes created by users, if any, get registered. Using notes manager, users can add new note as well as update previous notes. All the notes created by the users are stored in the database along with the object ID, user ID and other relevant user information. The notes created by users can either be private or public. Private notes are visible to only the user who created the note whereas public notes are visible to the all users working on that particular object.

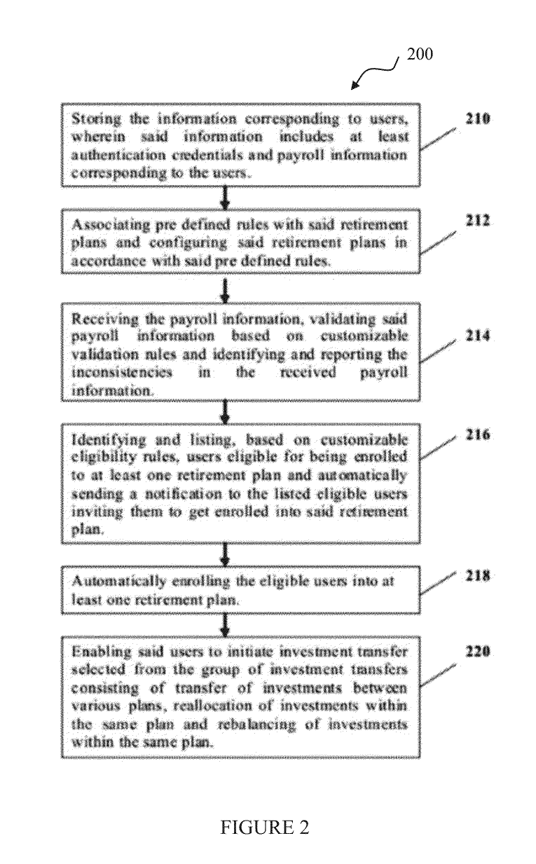

Referring to FIG. 2, there is provided a flowchart 200 detailing the steps involved in the method for facilitating aggregating, analyzing, and distributing of information corresponding to retirement plans offered to users. The method, in accordance with the present disclosure includes the following steps:
storing the information corresponding to users, wherein said information includes at least authentication credentials and payroll information corresponding to the users 210;
associating pre-defined rules with said retirement plans and configuring said retirement plans in accordance with said pre-defined rules 212;
receiving the payroll information, validating said payroll information based on customizable validation rules and identifying and reporting the inconsistencies in the received payroll information 214;
identifying and listing, based on customizable eligibility rules, users eligible for being enrolled to at least one retirement plan and automatically sending a notification to the listed eligible users inviting them to get enrolled into said retirement plan 216;
automatically enrolling the eligible users into at least one retirement plan 218; and
enabling said users to initiate investment transfer selected from the group of investment transfers consisting of transfer of investments between various plans, reallocation of investments within the same plan and rebalancing of investments within the same plan 220.

In accordance with the present disclosure, the step of storing the information corresponding to users in an encrypted format further includes the step of storing at least pre-defined configuration rules, eligibility rules, list of eligible users, employee details and user investment details.

In accordance with the present disclosure, the step of receiving the payroll information further includes the step of creating payroll profiles corresponding to each of the users.

In accordance with the present disclosure, the step of identifying and listing, based on customizable eligibility rules, users eligible for being enrolled to at least one retirement plan further includes the step of generating interlinked summary reports and detailed reports corresponding to the users.

In accordance with the present disclosure, the step of automatically enrolling the eligible users further includes the step of automatically transmitting a personalized enrollment confirmation to the users enrolled onto the retirement plan.

In accordance with the present disclosure, the method that includes the steps of optionally updating the payroll profiles corresponding to the users, further includes the step of optionally modifying at least the beneficiary list(s) of the retirement plans corresponding to the user's payroll profile.

In accordance with the present disclosure, the method includes the step of performing certificate based authentication to verify authentication credentials of the users.

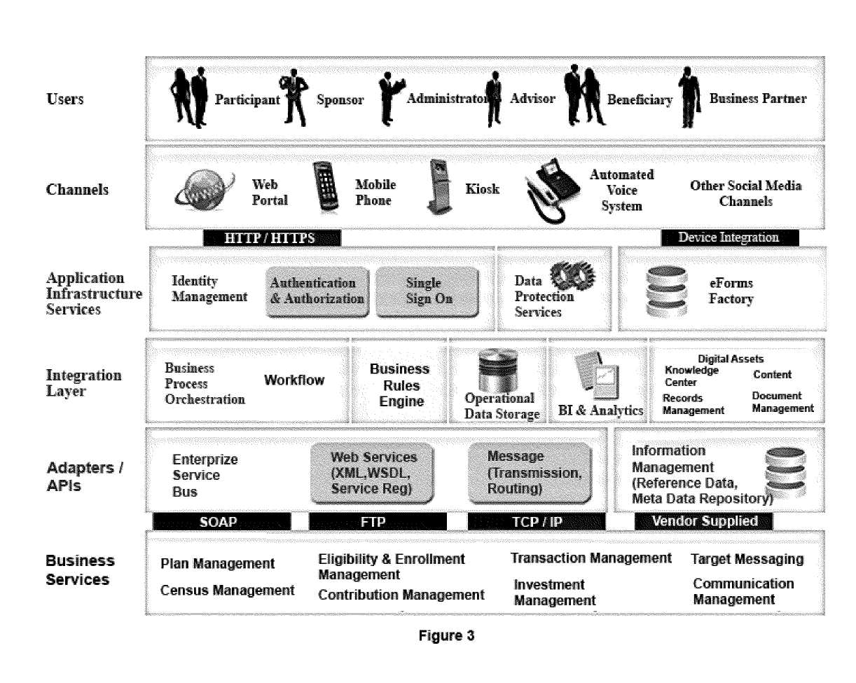

Referring to FIG. 3, there is shown a schematic representation of the components of the system 10 for aggregating, analyzing, and distributing information corresponding to retirement plans offered to users. The “users” column in FIG. 3 denotes the stakeholders of the system 10. The stakeholders of the system 10 include the participant (users who enroll for the retirement plan), sponsors (typically, the employer who offers retirement benefits to their employees), administrator (the organization/individual who takes care of the formalities corresponding to providing retirement benefits to users and administers the plans enrolled onto, by users), advisor (typically, third party advisors who advise users in respect of retirement plans), beneficiary or beneficiaries (typically, the people nominated by the users enrolling onto the retirement plan) and business partner.

The second level, in the architectural overview, as described in FIG. 3 involves the “channels” that could be utilized to access the system 10. In accordance with the present disclosure, all of the aforementioned stakeholders can access the system 10 using either a web portal, a GPRS enabled mobile phone (including iPhone), a computerized kiosk, an automated voice system or any other relevant social media channels. The communication between the aforementioned ‘channels’ and the ‘stakeholders’ takes place via protocols including HTTP (Hypertext Transfer Protocol) or HTTPS (Hypertext Text Transfer Protocol Secured). The third level of the architecture of the system 10 includes “application infrastructure services”, which includes an identity management system. The task of the identity management system is to authenticate and authorize the stakeholders of the system based on the authentication credentials which typically include at least a username and a password.

The application infrastructure component further includes a ‘single sign on’ system which, through device integration enables the stakeholders to log on to the system 10 using a single set of authentication credentials and through a single log-in process across multiple channels of communication which have been described in the “channels” section. The “application infrastructure services” component further includes ‘data protection services’ which ensure the safety of the information (at least the payroll information, retirement plan related information and authentication credentials corresponding to the users) by storing the information in an encrypted format and by preventing unauthorized users from having access to the information. The “application infrastructure services” component further includes an “e-forms factory” which generates all the necessary forms to be utilized by the stakeholders of the system 10. The e-forms factory makes use of the concept of device integration to make the necessary forms available across the multiple channels of communication subsequent to a single log-in process initiated by the stakeholders of the system 10.

The system 10 includes application programming interface (API) comprising a set of computer implemented instructions or routines to accomplish or provide interactions among the various intra as well as inter functionality modules/components. The system 10 needs to communicate with various user groups at various points in time for a multitude of reasons. To enable these interactions, the system 10 has been adapted to enable the stakeholder users to receive information not only from the system but also from other stakeholders, thereby, the enabling API's facilitates inter functionality interactions. The system 10 includes a message center adapted to send internet and intranet messages/notifications such as inbox messages or email. The message center posts the data into a temporary mailing list. The temporary mailing list reads the data posted by the message center and initiates a mailing system to send the mail. Schedules for the mailing service can be adjusted by an administrator.

The system 10 also has the ability to send messages to users through the intranet. To achieve this, the message center posts the data into a specified table which then gets rejected in the relevant stakeholder's home page. The system 10, through the message center provides error messages that make it easy for the users to identify the occurrence of errors, if any and undertake the necessary preventive action. The exception/errors generated by the system 10 are optionally routed to the user in the form of a message. The messages are typically routed in the form of emails. The APIs of the system 10 further include an information management system which holds the reference data required by the stakeholders (data including but not restricted to stakeholder information, information corresponding to occurrence of errors) and also the corresponding metadata.

In accordance with the present disclosure, the architecture of the system 10 as described in FIG. 3 further includes an integration layer. The integration layer includes customized workflows which are managed via a business rules engine which is adapted to determine the course of business workflow of the system 10. The business rules engine is utilized to execute several rules that govern the working of the system 10. For example, the businesses work how engine executes the validation rules for validating the payroll information corresponding to the users.

The business workflow engine, for example, also executes the eligibility rules for identifying the users who are eligible for obtaining a retirement plan. The business rules engine also provides for the business rules to be modified, if necessary. The integration layer further includes an operational data storage which acts as a repository and holds all the necessary business/operational data including but not restricted to user payroll information, retirement plan related information and eligibility information. The integration layer of the system 10 includes an analytical engine that is adapted to receive information/messages/query transmitted by the stakeholders and further adapted to process the stakeholder query/message to transmit the desired information back to the stakeholder. The integration layer of the system 10 includes a digital assets section, a knowledge center, a records-management module which manages the records corresponding to the stakeholders, a document-management module which is adapted to manage all the documents received by/to be provided to the stakeholders of the system 10.

The fourth component of the system are Application Programmer Interfaces (APIs) which include Web services such as XML (Extensible Markup Language) and WSDL (Web Services Definition Language) which are typically utilized to facilitate communication between the system 10 and the various stakeholders of the system. The APIs of the system further include a messaging system which typically facilitates communication between the system 10 and stakeholders and also the communication between the various stakeholders via transmission/routing of messages.

In FIG. 3, the bottom most layer, includes the component termed “business services” which involves the working components (described in FIG. 1) of the system 10. The working components described in FIG. 3 are merely representative and it is possible to add/delete the components from the architecture of the system 10 without departing from the scope of the disclosure. The working components of the system 10 includes computer protocols such as Simple Object Access Protocol (SOAP), Transmission Control Protocol/Internet Protocol (TCP/IP), File Transfer Protocol (FTP) and a vendor supplied protocols. The SOAP forms the foundation layer of a web service protocol stack, providing a basic messaging framework upon which web services can be built. SOAP can be used over any transport protocol such as Hypertext Transfer Protocol (HTTP), Simple Mail Transfer Protocol (SMTP), Transfer Control Protocol (TCP) and Java Message Service (JMS).

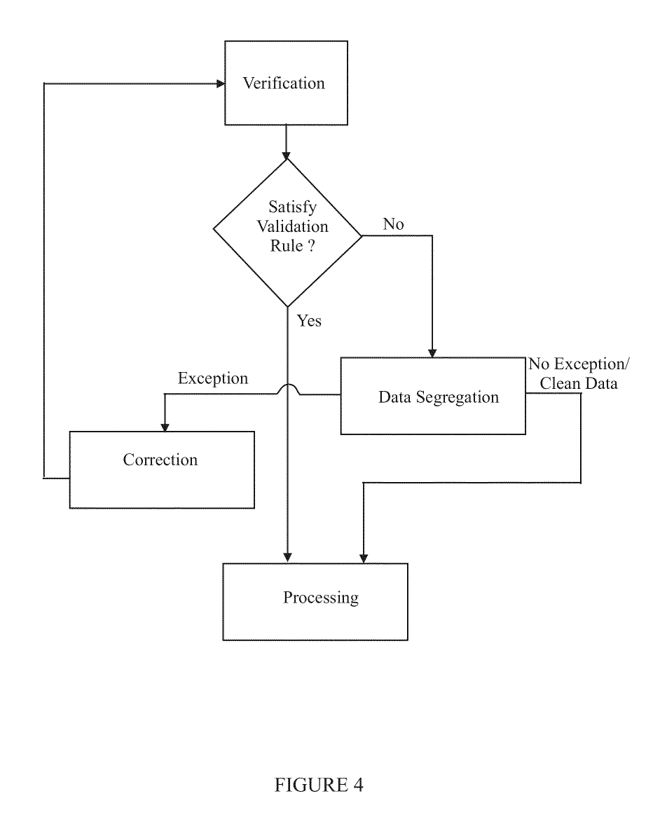

Referring to FIG. 4, the verification sub-system 18 is used to read the data from the database and verify profiles of the data generated by the payroll module 16 based on the validation rules. A validation rule is enforced on the data. The validation rules are customizable as per requirement. The validation rules identify exceptions. If no exceptions are found, the dataset is forwarded for further processing. If the dataset carries exception it is segregated, process represented at the data-segregation sub-system 22. The data-segregation sub-system 22 segregates the dataset into two parts. The first constituting the dataset which carry exceptions, while the second, constituting the dataset which does not carry any exception. The part which carry exceptions are forwarded to the correction sub-system 24.

At the correction sub-system 24, the exceptions are displayed on a user interface and the plan sponsor/administrator is given the provision to correct the exceptions in line with the validation rules. The above mentioned cycle repeats until all the dataset is error free. This procedure avoids the need to hold the entire dataset in lieu of correcting only a few data points. The advantage addressed by the correction sub-system 24 is to reduce the error correction cycle time. Prior technology would require a substantial amount of time, period ranging from one week to a few months to identify and rectify the exceptions. With abovementioned procedure, this period is reduced to matter of a few minutes and hence proving time and money saving. Also, the system greatly reduces the role of human intervention in the process of error/exception correction.

### TECHNICAL ADVANCEMENTS

The technical advancements of the present disclosure include:
providing a system that implements a web based self-service platform;
providing a system that captures the necessary information at the source without losing the control over the process of capturing the information;
envisaging a system that provides highly automated business processes;
making available a system that provides customizable plan templates and customizable work how structures;
providing a system that ensures data concurrency by isolating the transactions performed on the stored data;
providing a system that offers services which greatly reduce the time required for error/exception identification and rectification;
providing a system that offers services which are cost and time saving; and
providing a system which automates the error/exception identification and rectification.

Throughout this specification the word “comprise”, or variations such as “comprises” or “comprising”, Will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

I claim:

1. A computer implemented system for managing information related to users and corresponding retirement plans offered to users, said system comprising:
a database adapted to store the information corresponding to different users and retirement plans available, wherein the information includes at least authentication credentials, payroll information, predefined rules related to different retirement plans and predefined validation rule;
configuration sub-system adapted to assign a retirement plan to a user based on payroll information for said user and predefined rules associated with said retirement plans;
payroll module adapted to generate data by creating a profile corresponding to each user, wherein profile corresponding to each user is created by extracting payroll information corresponding to each user and information regarding a retirement plan assigned to each user from said database, said payroll module further adapted to utilize customizable validation rules for validating each profile created corresponding to each user;
an eligibility module having customizable eligibility rules for identifying and listing users eligible for being enrolled in at least one retirement plan, said eligibility module further adapted to automatically send a notification to listed eligible users inviting them to get enrolled into said retirement plan;
an enrollment module adapted to automatically enroll the eligible users into at least one retirement plan;
a verification sub-system adapted to verify profiles of said data generated by said payroll module based on said validation rules;
a exception-management sub-system adapted to identify exceptions in the data generated by said payroll module, wherein said exceptions include profiles having erroneous entries and which deviate from said validation rules;
a data-segregation sub-system adapted to segregate a portion of said data having said exceptions from said data without exceptions, wherein said data without exceptions proceeds for further processing;
a correction sub-system adapted to correct said data having exceptions and direct rectified data to said exception-management sub-system;
a processing engine adapted to update the data at the payroll module, so that all profiles are free of exceptions, said processing engine further adapted to direct data for end use;
a transfer sub-system adapted to enable said users to initiate investment transfer selected from the group of transfer of investments between various plans, reallocation of investments within the same plan and, rebalancing of investments within the same plan.

2. The system as claimed in claim 1, wherein said system further includes updating means adapted to periodically update the payroll profiles corresponding to said users, said updating means further adapted to facilitate at least one modification in the beneficiary list(s) of the retirement plans corresponding to the user's payroll profile.

3. The system as claimed in claim 1, wherein said database is further adapted to store at least said pre-defined configuration rules, eligibility rules, list of eligible users, employee details and user investment details.

4. The system as claimed in claim 1, wherein said eligibility module is further adapted to generate summary reports having at least the payroll details corresponding to eligible users, and detailed reports, said eligibility module further adapted to interlink said summary reports with said detailed reports.

5. The system as claimed in claim 1, wherein said enrollment module is adapted to automatically transmit a personalized enrollment confirmation to the users enrolled into said retirement plans.

6. The system as claimed in claim 1, wherein said system includes a user interface adapted to display the items selected from the group of items consisting of at least payroll profiles, beneficiary lists, user information, user account summary, investment details, transaction history, retirement plan details, contribution details, retirement plan wise investment details and performance of the investment for a particular plan.

7. The system as claimed in claim 1, wherein said system further includes authentication means communicating with said database and having pre-defined authentication rules and adapted to perform certificate based authentication to verify authentication credentials of the users.

8. A computer implemented method for aggregating, analyzing, distributing information corresponding to retirement plans offered to users, said method comprising the following steps:
a) storing the information corresponding to users, wherein said information includes at least authentication credentials and payroll information corresponding to said users;
b) associating pre-defined rules with said retirement plans and configuring said retirement plans in accordance with said pre-defined rules;
c) verifying profiles of said data generated by said payroll module based on said validation rules;
d) identifying exceptions, said exceptions include said data which fail said validation rules;
e) segregating said data which carry said exceptions from those that do not carry said exceptions;
f) correcting said data which carry said exceptions;
g) re-validating said payroll information with corrected exceptions;
h) repeating steps c to g until the exceptions are corrected;
i) forwarding said data for further processing;
j) identifying and listing, based on customizable eligibility rules, users eligible for being enrolled to at least one retirement plan and automatically sending a notification to the listed eligible users inviting them to get enrolled into said retirement plan;
k) automatically enrolling the eligible users into at least one retirement plan; and
l) enabling said users to initiate investment transfer selected from the group of investment transfers consisting of transfer of investments between various plans, reallocation of investments within the same plan and rebalancing of investments within the same plan.

9. The method as claimed in claim 8, wherein the step of storing the information corresponding to users in an encrypted format further includes the step of storing at least pre-defined configuration rules, eligibility rules, list of eligible users, user information and user investment details.

10. The method as claimed in claim 8, wherein the step of receiving the payroll information further includes the step of creating payroll profiles corresponding to each of said users.

11. The method as claimed in claim 8, wherein the step of identifying and listing, based on customizable eligibility rules, users eligible for being enrolled to at least one retirement plan further includes the step of generating interlinked summary reports and detailed reports corresponding to said users.

12. The method as claimed in claim 8, wherein the step of automatically enrolling the eligible users further includes the step of automatically transmitting a personalized enrollment confirmation to the users enrolled onto said retirement plan.

13. The method as claimed in claim 8, wherein the method further includes the steps of optionally updating the payroll profiles corresponding to the users and optionally modifying the beneficiary lists corresponding to said retirement plans enrolled onto said users.

14. The method as claimed in claim 8, wherein the method includes the step of performing certificate based authentication credentials of said user.

15. A computer program product, comprising a computer usable medium having a computer readable program code embodied therein, said computer readable program code adapted to be executed to implement a method for generating a report, said method comprising:
a) storing the information corresponding to users, wherein said information includes at least authentication credentials and payroll information corresponding to said users;
b) associating pre-defined rules with said retirement plans and configuring said retirement plans in accordance with said pre-defined rules;
c) verifying profiles of said data generated by said payroll module based on said validation rules;
d) identifying exceptions, said exceptions include said data which fail said validation rules;
e) segregating said data which carry said exceptions from those that do not carry said exceptions;
f) correcting said data which carry said exceptions;
g) re-validating said payroll information with corrected exceptions;
h) repeating steps c to g until the exceptions are corrected;
i) forwarding said data for further processing;
j) identifying and listing, based on customizable eligibility rules, users eligible for being enrolled to at least one retirement plan and automatically sending a notification to the listed eligible users inviting them to get enrolled into said retirement plan;
k) automatically enrolling the eligible users into at least one retirement plan; and
l) enabling said users to initiate investment transfer selected from the group of investment transfers consisting of transfer of investments between various plans, reallocation of investments Within the same plan and rebalancing of investments within the same plan.
